(19) United States
(12) Patent Application Publication
(10) Pub. No.: US 2005/0184224 A1
(43) Pub. Date: Aug. 25, 2005

(54) Object detecting apparatus

(76) Inventor: Makoto Inomata, Handa-city (JP)

Correspondence Address: HARNESS, DICKEY & PIERCE, P.L.C., P.O. BOX 828, BLOOMFIELD HILLS, MI, 48303, US

(21) Appl. No.: 11/051,803

(22) Filed: Feb. 4, 2005

(30) Foreign Application Priority Data
Feb. 19, 2004 (JP) 2004-043183

(51) Int. Cl. G01C 3/08; G01V 8/00

(52) U.S. Cl. 250/221; 250/559.38; 356/4.01

(57) ABSTRACT

An object detecting apparatus comprises a light radiation unit and a light receiver unit disposed in a space defined between a first case and a second case. The first case is made of light-blocking material, and the second case is made of light-transmitting material. The first case and the second case have respective flanges that contact each other along the entire periphery. The flanges are laser-welded air-tightly by radiating laser light to the flange of the first case through the flange of the second case.

### CROSS REFERENCE TO RELATED APPLICATION

This application is based on and incorporates herein by reference Japanese Patent Application No. 2004-43183 filed on Feb. 19, 2004.

### FIELD OF THE INVENTION

The present invention relates to an object detecting apparatus mounted on a vehicle, for instance, for detecting an object such as a preceding vehicle or a distance to such an object by using an electromagnetic wave such as a light wave.

### BACKGROUND OF THE INVENTION

A conventional object detecting apparatus mounted on a vehicle uses a laser light, for instance, to detect a distance to an object such as a preceding vehicle. This detecting apparatus intermittently drives a laser diode to radiate the laser light towards the forward area of the vehicle, and detects the light reflected from the forward obstacle by a photo sensor. The detecting apparatus measures the distance to the forward obstacle based on a time difference between a light radiation time and a light receiving time.

Specifically, as disclosed in JP 2002-031685A, the detecting apparatus comprises a light radiation unit for radiating a laser light, a polygon mirror and a light receiver unit for receiving a reflected light. The polygon mirror is shaped in a frustum of a hexagonal pyramid and rotatable as a scanning mirror. According to this construction, the polygon mirror reflects the laser light radiated from the light radiation unit and directs it to the forward area of the vehicle. As the polygon mirror is rotated and the laser light from the light radiation unit is directed to each side surface of the polygon mirror, so that the angle of reflection of the laser light at the polygon mirror is adjusted to scan a predetermined range of the forward area of the vehicle by the laser light. The receiver unit includes a Fresnel lens and a light receiving element to receive the laser light reflected from the forward object and measure the distance to the object.

Various component parts of the apparatus including the above parts are accommodated within a closed case so that a scanning mechanism, optical devices and electronic circuits are protected from frosting of water or foreign matters such as dust.

Specifically, as shown in FIG. 4, the case J1 is shaped generally in a cuboid and is comprised of a first case J2 and a second case J3. The four corners of the cases J2 and J3 are tightly fastened by fixing screws J5. As shown in FIG. 5, an O-ring J4 is disposed between the cases J2 and J3 in the compressed state to air-tightly seal the space in the case J1 from the outside.

To maintain the appropriate compression state of the O-ring J4 for the air-tight sealing function, the dimension, sealing surface roughness or the like of the O-ring J4 must be accurately controlled. Further, the O-ring J4 must be accurately assembled to the case J3.

### SUMMARY OF THE INVENTION

It is therefore an object of the present invention to provide an object detecting apparatus, which simplifies a sealing structure of cases.

According to the present invention, an object detecting apparatus comprises a wave radiation unit and a wave receiver unit disposed in a space defined between a first case and a second case. The first case is made of light-blocking material, and the second case is made of light-transmitting material. The first case and the second case have respective flanges that contact each other along the entire periphery. The flanges are laser-welded air-tightly by radiating laser light to the flange of the first case through the flange of the second case.

### BRIEF DESCRIPTION OF THE DRAWINGS

The above and other objects, features and advantages of the present invention will become more apparent from the following detailed description made with reference to the accompanying drawings. In the drawings:

FIG. 1 is a perspective view of an object detecting apparatus according to an embodiment of the present invention;

FIG. 2 is a sectional view of the apparatus shown in FIG. 1;

FIG. 3 is a sectional view of a sealing structure of the apparatus taken along III-III in FIG. 1;

FIG. 4 is a perspective view of a conventional object detecting apparatus; and

FIG. 5 is a sectional view of a sealing structure in the conventional apparatus.

### DETAILED DESCRIPTION OF THE PREFERRED EMBODIMENT

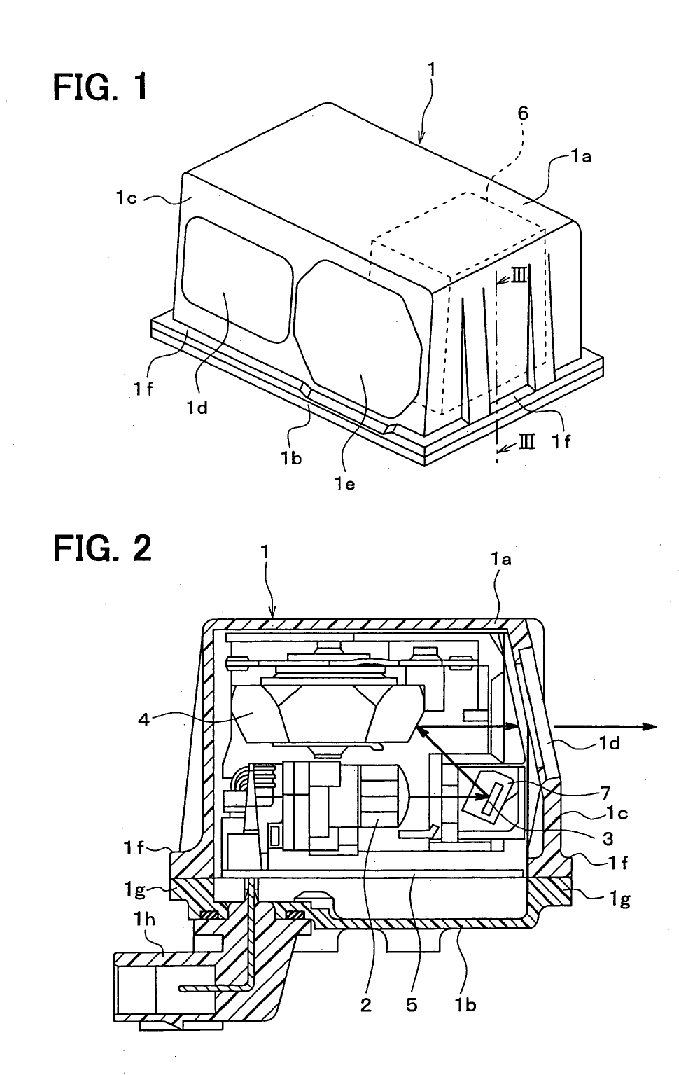

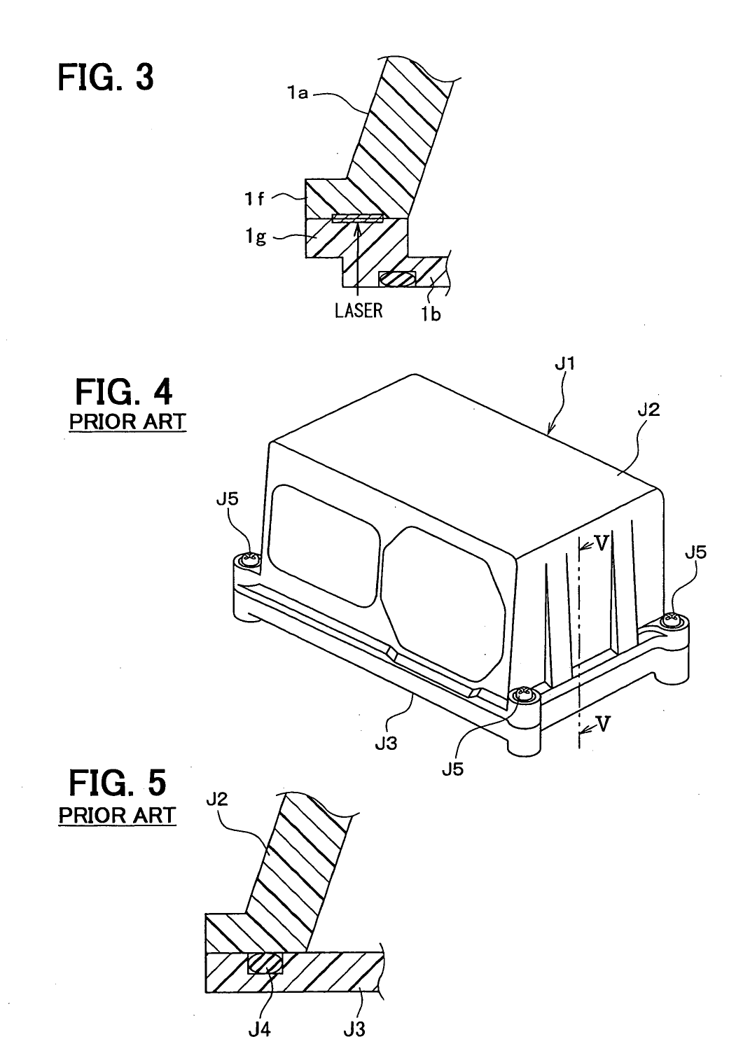

Referring first to FIGS. 1 and 2, an object detecting apparatus includes a case 1 shaped in a cuboid and various component parts accommodated in the case 1. The apparatus is mounted on a vehicle to be used as a laser radar. The apparatus is positioned to radiate a laser light in the forward direction of the vehicle (rightward direction in FIG. 2) to detect a distance to a forward object such as a preceding vehicle during an auto-cruise control condition.

The case 1 includes a first case 1a and a second case 1b. The first case 1a is box-shaped and open at its one side (bottom side in FIG. 2). The first case 1a accommodates therein various component parts. The first case 1a has a resin part 1c made of black PPS resin and form a housing. The first case 1a has a light radiating window 1d and a light receiving window 1e arranged at the left and the right sections on the front-side resin part 1d. The windows 1d and 1e may be made of light transmitting resin such as glass and acrylic resin.

The resin part 1c of the first case 1a is made of laser light blocking material such as black PPS resin, which includes glass of about 40 wt.%. Thus, the resin part 1c does not transmit or less transmit the laser light. The resin part 1c has a first flange if along an entire length around the opening so that the first case 1a, particularly the flange 1f, is joined to the second case 1b.

The second case 1b is made of a plate-shaped material and shaped to have a second flange 1g, which corresponds to the shape of the flange 1f along an entire length around the opening of the first case 1a. The second case 1b is made of laser light transmitting material such as black PPS resin containing no glass. The flanges if and 1g are laser-welded to each other.

The second case 1b has an electrical connector 1h made of resin. The connector 1h partly projects from the second case 1b to connect the electrical parts (not shown) provided inside and outside the case 1.

The case 1 (1a and 1b) accommodates a light radiation unit 2, a reflection mirror 3, a polygon mirror 4 and an electric circuit board 5. The circuit board 5 includes an electronic control circuit, which are connected to the light radiation unit 2, a light receiving unit 6 and the like to measure the distance to the forward object. The light receiving unit 6 is positioned inside the case 1 to face the light receiving window 1e and includes a Fresnel lens and a light receiving element.

The light radiation unit 2 is driven by the control circuit provided on the circuit board 5 and radiates the laser light towards the reflection mirror 3. The light radiation unit 2 may include a laser diode to radiate the laser light in the pulse form.

The reflection mirror 3 reflects the laser light radiated from the radiation unit 3 and directs it to the polygon mirror 4. The reflection mirror 3 is supported swingably to the inner case 1c by a support part 7 fixed to the inside wall of the case 1. For instance, the reflection mirror 3 may be driven by a motor (not shown) and controlled by the electric circuit of the circuit board 5 to adjust the direction of reflection.

The polygon mirror 4 is shaped in a frustum hexagonal prism and supported by the case 1. The mirror 4 is rotatable about an axis of the hexagonal prism. This mirror 4 is also driven by a motor (not shown) controlled by the control circuit of the circuit board 5. The polygon mirror 4 has around its periphery mirror faces, each of which operates as a scanning reflection mirror.

Specifically, the polygon mirror 4 reflects the laser light radiated from the radiation unit 2 and reflected by the reflection mirror 3, and directs the laser light toward the vehicle forward area through the radiating window 1d. As the polygon mirror 4 is rotated, the angle of the side face of the polygon mirror 4 changes. As a result, the angle of projection of the laser light is changed to scan a predetermined forward area of the vehicle.

The light receiver unit 6 includes the Fresnel lens and the light receiving element such as a photo diode. The Fresnel lens collects the laser light reflected from the forward object and received through the window 1e. The light receiving element receives the collected light and produces an output voltage or output current varying with the intensity of the received light. The output voltage or current is applied to the control circuit of the circuit board 5.

In manufacturing the apparatus, the light radiation unit 2, reflection mirror 3, polygon mirror 4 and the light receiver unit 6 are fixed to the second case 1b together with the circuit board 5. Then the first case 1a is placed on the second case 1b such that the flanges 1f and 1g contact each other. Thus, the first case 1a covers the light radiation unit 2, reflection mirror 3, polygon mirror 4, circuit board 5 and the light receiver unit 6. The flanges 1f and 1g are laser-welded along the entire length of the flanges, that is entire periphery of the cases 1a and 1b.

In the laser-welding process, a welding laser light is radiated toward the flange if through the flange 1g. Since the second case 1b is made of light-transmitting material, the laser light passes the flange 1g and reaches the flange 1f. Since the first case 1a is made of light-blocking (non-light-transmitting) material, the laser light is blocked by the flange 1f. Thus, the border between the flanges 1f and 1g is heated and the flanges 1f and 1g are air-tightly welded to each other.

The object detecting apparatus constructed and manufactured as above operates in the following manner, assuming that it is mounted in a vehicle and an auto-cruise control system switch is turned on. The following operation is mostly controlled by the control circuit of the circuit board 5.

The reflection mirror 3 is first driven to a predetermined angular position by the motor. The light radiation unit 2 radiates the laser light at predetermined intervals. The laser light is reflected by the reflection mirror 3 and the polygon mirror 4 to be directed toward the forward area of the vehicle through the radiating window 1d as shown with an arrow in FIG. 2. When the laser light is reflected by an object such as a preceding vehicle, the reflected light passes the light enters the light receiver unit 6 through the light receiving window 1e.

In the light receiver unit 6, the reflected light is collected by the Fresnel lens and received by the light receiving element. The light receiving element generates an output signal in response to the reception of the collected light. Based on this output signal, the control circuit calculates a distance L to the forward object by using the laser light travel speed V and the time difference T between the laser light radiation by the radiation unit 2 and the reception of the laser light by the light receiver unit 6: L =V×T/2.

The calculated distance is output through the connector 1h to various devices such as an engine control ECU and a brake control ECU provided outside the case 1. As a result, the ECUs may control an engine and/or brakes to maintain the distance to the object at a predetermined distance.

According to the above embodiment, the first case 1a and the second case 1b are laser-welded to each other air-tightly without using an O-ring. Thus, various drawbacks caused in using the O-ring are obviated.

In the above embodiment, the light transmittivity of the first case 1a and the second case 1b may be reversed such that the first case 1a and the second case 1b are made of light-transmitting resin and light-blocking resin. In this instance, laser light is radiated toward the second case 1b (flange 1g) through the first case 1a (flange 1f).

The light-blocking resin including glass material is more rigid than the light-transmitting resin. It is therefore preferred to use the light-blocking resin for one of the cases 1a and 1b that is required to be more rigid than the other. When the apparatus is mounted in a vehicle, the first case 1a is more likely to be hit and broken by small stones or the like during vehicle travel. Therefore, the first case 1a is preferably made of the light-blocking resin.

The above embodiment may further be modified. For instance, other electromagnetic waves such as a milliwave may be used in place of the laser light wave. The object detecting apparatus maybe used in various situations other than vehicles.

1. An object detecting apparatus for detecting an object, the apparatus comprising:
a first case having an opening;
a second case fixed to the first case to close an opening of the first case and provide an inside space with the first case;
a wave radiation unit disposed in the space for radiating an electromagnetic wave outward; and
a wave receiver unit disposed in the space for receiving the electromagnetic wave reflected by the object,
wherein the first case and the second case are welded to each other around the opening of the first case along an entire periphery of the opening.

2. The object detecting apparatus as in claim 1, wherein the first case and the second case has flanges along the periphery of the opening, respectively, that contact each other and welded to each other air-tightly.

3. The object detecting apparatus as in claim 1, wherein the first case and the second case are made of one and the other of light-transmitting material and light-blocking material, respectively, and the flanges are welded by laser light.

4. The object detecting apparatus as in claim 3, wherein the first case is made of the light-blocking material, the second case is made of the light-transmitting material, and the laser light is radiated to the flange of the first case through the flange of the second case.

5. The object detecting apparatus as in claim 1, wherein the first case has a radiating window that passes the electromagnetic wave radiated by the radiation unit and a receiving window that passes the electromagnetic wave reflected by the object to the receiver unit.
